(19) United States
(12) Patent Application Publication
(10) Pub. No.: US 2020/0214399 A1
(43) Pub. Date: Jul. 9, 2020

(54) WEB ADJUSTER

(71) Applicant: Shield Restraint Systems, Inc,, Elkhart, IN (US)

(72) Inventor: Phillip Dale Morgan, Nobiesviiie, IN (US)

(21) Appl. No.: 16/240,196

(22) Filed: Jan. 4, 2019

(51) Int. Cl. A44B 11/12; B60R 22/30

(52) U.S. Cl. CPC A44B 11/125; B60R 22/30

(57) ABSTRACT

Web adjusters for use with occupant restraint systems are described herein. In some embodiments, a web adjuster includes a cross bar operably coupled to a frame, and a release member that is pivotally coupled to the frame and configured to cooperate with the cross bar. In use, a web can be routed through the adjuster so that it passes around the cross bar and between the cross bar and a locking surface of the release member. A user can increase tension in the web by pulling a free end portion of the web through the adjuster. When the free end portion is released, the tension in the web drives the cross bar toward the locking surface to fixedly clamp the web therebetween and maintain the tension in the web. To release the tension in the web, the user can rotate the release member away from the frame, thereby moving the locking surface away from the cross bar and permitting the web to pass through the adjuster.

### TECHNICAL FIELD

The present disclosure is generally directed to web adjusters for use with seat belts and other webs.

### BACKGROUND

Personal restraint systems for use in automobiles and other vehicles are well known. Such systems can include, for example, seat belts for use by adults and children of sufficient size, and child seats for use with smaller children and toddlers.

Conventional child seats are typically configured to be mounted on a passenger seat in an automobile or other vehicle. Such child seats are typically secured to the passenger seat by one or more belts or webs that extend from the child seat to a corresponding anchor point in the vehicle. The length and tension in the web is typically adjusted by use of a web adjustor that joins two sections of web together. Examples of web adjusters are disclosed in, for example, U.S. Pat. Nos. 5,160,186 and 3,872,550; U.S. patent application Ser. No. 15/890,239, titled “WEB ADJUSTER” and filed on Feb. 6, 2018; and U.S. patent application Ser. No. 16/203,529, titled “WEB ADJUSTER” and filed on Nov. 28, 2018; each of which is incorporated herein by reference in its entirety.

Web adjusters enable a user to increase tension in a web by pulling a free end portion of the web (also referred to as the “adjust end”) through the adjuster to tighten the web and lock the adjuster in tension. The user can unlock the adjuster and release the tension by, e.g., depressing a button if it is a push-button type adjuster, or by rotating the entire adjuster if it is a “tilt lock” adjuster. Such web adjusters, however, may require considerable force to manually unlock the adjuster, especially when the web is under full tension. Accordingly, it would be advantageous to provide a web adjuster that requires a relatively low force to unlock the adjuster.

### BRIEF DESCRIPTION OF THE DRAWINGS

FIG. 1A is an isometric view of a web adjuster configured in accordance with embodiments of the present technology; FIGS. 1B, 1D and 1E are a series of partially exploded isometric views of the web adjuster; and FIG. 1C is a bottom isometric view of an adjuster release member configured in accordance with embodiments of the present technology.

FIGS. 2A-2C are a series of side cross-sectional views illustrating operation of the web adjuster of FIGS. 1A-1D in accordance with embodiments of the present technology.

FIG. 3 is a side view of a child seat secured to a vehicle seat with a restraint system having a web adjuster configured in accordance with embodiments of the present technology.

### DETAILED DESCRIPTION

The following disclosure describes various embodiments of web adjusters for use with child seat tethers and/or other personal restraint systems in automobiles and other vehicles. In some embodiments, a web adjuster configured in accordance with the present technology can include a movable cross bar and a pivotable release member operably coupled to a frame. The cross bar can be configured to support a web routed around the cross bar and generally between the cross bar and a locking surface portion of the release member. When the release member is in a first position (e.g., a lock position), the locking surface portion is positioned generally in front of the cross bar. As a result, when a user pulls a free end portion of the web through the adjuster, the web slides between the cross bar and the locking surface portion as tension in the web is increased. When the user releases the free end portion, the tension in the web pulls the cross bar toward the locking surface portion, securely clamping the web therebetween to maintain tension in the web. To release the tension in the web, the user can move (e.g., rotate) the release member away from the first position toward a second position (e.g., an unlock or release position). This moves the locking surface portion away from the cross bar, thereby enabling the web to slide back through the adjuster and relieve the tension. These and other features of web adjusters configured in accordance with embodiments of the present technology are described in greater detail below.

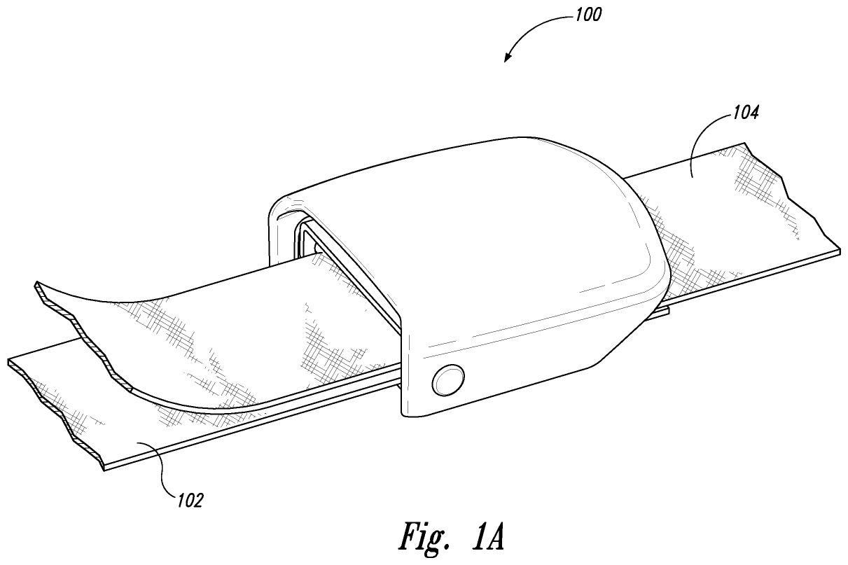

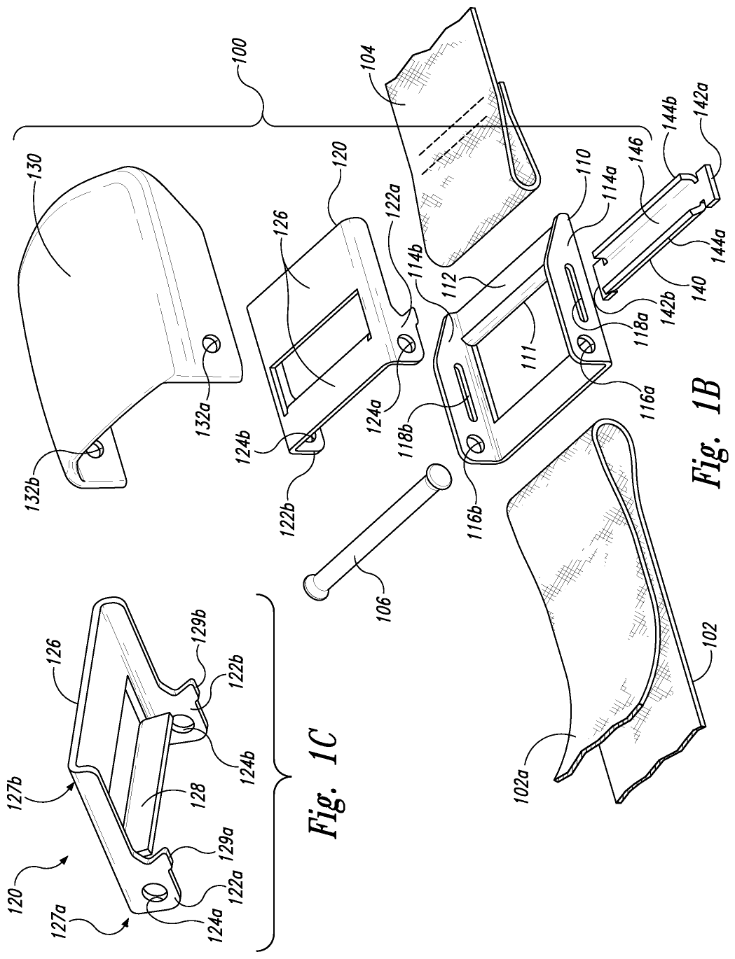

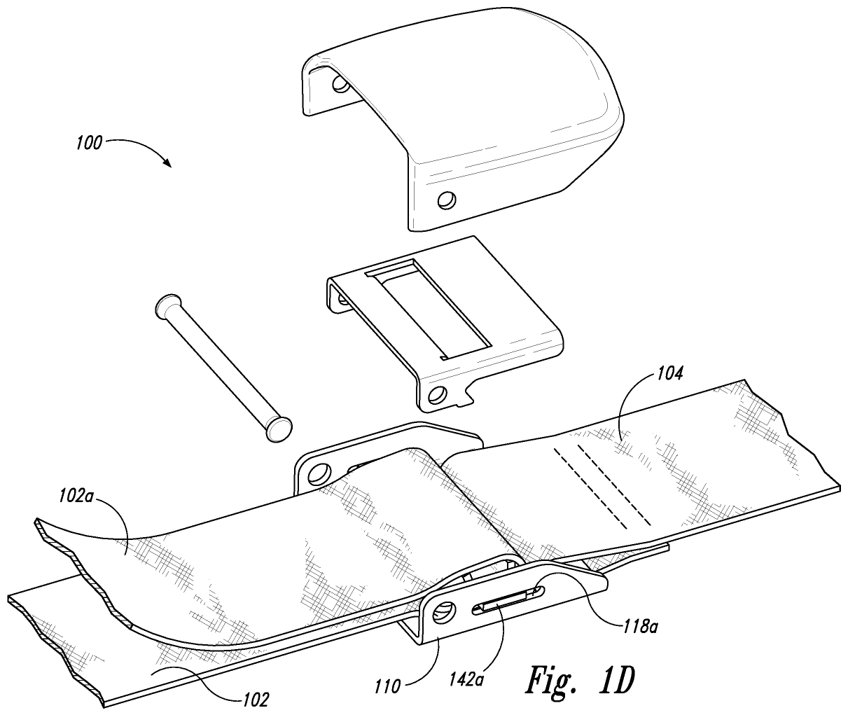

Certain details are set forth in the following description and in FIGS. 1A-3 to provide a thorough understanding of various embodiments of the present technology. In other instances, well-known structures, materials, operations and/or systems often associated with web adjusters, seat belt webs, child seats and/or other personal restraint system hardware are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the scope of the present invention. Those of ordinary skill in the art will also appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1A is an isometric view of a web adjuster 100 configured in accordance with embodiments of the present technology. FIGS. 1B, 1D and 1E are a series of partially exploded isometric views of the web adjuster 100, and FIG. 1C is a bottom isometric view of a web adjuster release member configured in accordance with embodiments of the present technology. Referring first to FIGS. 1A and 1B together, the web adjuster 100 can be used to operably join a first web 102 (e.g., an “adjust web”) to a second web 104 (e.g., an “anchor web”). The web adjuster 100 includes a frame 110 having a first side wall 114a and a second side wall 114b extending upwardly from opposite sides of a base 112. The base 112 includes a web aperture 111. The first side wall 114a includes a first opening 118a and the second side wall 114b includes a second opening 118b. In the illustrated embodiment, the openings 118a, b are in the form of elongate slots that extend parallel, or at least approximately parallel, to the base 112. (Accordingly, for ease of reference the openings 118a, b may be referred to herein as “slots 118a, b”.) In other embodiments, the openings 118a, b may have other shapes, sizes, orientations, etc. In addition to the foregoing features, the first side wall 114a further includes a first shaft or pin hole 116a, and the second side wall 114b further includes a corresponding second pin hole 116b.

The web adjuster 100 further includes a cross bar 140 having a first end portion 142a and a second end portion 142b. Referring to FIGS. 1B and 1D together, in some embodiments each of the end portions 142a, b can have a generally rectangular cross-sectional shape configured to be slideably received in the corresponding slots 118a, b, respectively, in the side walls 114a, b of the frame 110. By “slideably received” it should be understood that the end portions 142a, b are received in the corresponding slots 118a, b, respectively, in such a way that they can move (e.g., slide) fore and aft in the respective slots without substantial rotation.

As shown in FIG. 1B, in the illustrated embodiment the cross bar 140 further includes a first flange portion 144a and a second flange portion 144b that extend generally upward from opposite sides of a medial portion 146 to give the cross bar 140 a generally “U” shaped cross-section. In the illustrated embodiment, the flange portions 144a, b can include non-round exterior surfaces, such as generally flat exterior surfaces that face generally fore and aft, respectively. In other embodiments, the cross bar 140 and the flange portions 144a, b can have other shapes, sizes, orientations, etc. For example, in other embodiments it is contemplated that the cross bar 140 can have a round, or generally round cross-sectional shape.

As shown in FIG. 1D, the first web 102 can be routed over the base 112 of the frame 110 and around the cross bar 140 to define a free end portion 102a of the first web 102. Although not shown in FIG. 1D, the first web 102 can further include an opposite end portion that is spaced apart from the web adjuster 100. As described in greater detail below, the opposite end portion of the first web 102 can be secured to, for example, a child seat. The second web 104 can be looped through the web aperture 111 (FIG. 1B) before being stitched or otherwise attached to itself to securely attach the second web 104 to the frame 110. As also described in greater detail below, the opposite end portion of the second web 104 (e.g., the “tag end”) can carry, for example, a latch or other connecting device to fixedly attach the second web 104 to an anchor or other structure in a vehicle. Together, the first web 102 and the second web 104 can form a combined web that secures the child seat to the vehicle. The webs 102 and 104 can be any type of conventional restraint straps, seat belt webs, etc. known in the art, and can be constructed of various suitable materials and methods known in the art, such as woven nylon.

Referring to FIGS. 1B and 1C together, the web adjuster 100 further includes a release member 120 (e.g., a “release lever” or “lift lever”) having a first side flange 122a and a second side flange 122b extending downwardly from opposite sides of an upper wall 126. In the illustrated embodiment, the side flanges 122a, b are mirror images of each other and each includes a corresponding shaft or pin hole 124a, b positioned proximate a first end portion 127a of the release member 120. In some embodiments, each of the side flanges 122a, b can further include a corresponding stop surface 129a, b configured to abut the frame base 112 and prevent over-rotation when the release member 120 moves into a closed or locked position. As shown in FIG. 1C, the release member 120 further includes a locking surface portion 128 extending downwardly (e.g., in the form of a flange) from the upper wall 126 between the first side flange 122a and the second side flange 122b. In the illustrated embodiment, the locking surface portion 128 is longitudinally positioned between the central axis of the pin holes 124a, b and a second end portion 127b of the release member 120.

Referring next to FIGS. 1B and 1E together, the release member 120 is pivotally coupled to the frame 110 by means of a pivot shaft or pin 106 that extends through the pin holes 124a, b in the release member 120 and the corresponding pin holes 116a, b in the frame 110. As shown in FIG. 1E, the side flanges 122a, b of the release member 120 are positioned inside the side walls 114a, b of the frame 110 when the release member 120 is in the “lock” position. A cover 130 can be attached to the release member 120 to facilitate manual operation of the web adjuster 100. More specifically, in the illustrated embodiment the cover 130 can be configured to “snap” over or otherwise fit or clip onto and attach to the release member 120. In some embodiments, the cover can include openings 132a, b configured to receive the respective end portions of the pivot pin 106. In operation, a user can manually grasp an aft edge portion of the cover 130 and rotate the cover 130/release member 120 to or from the lock position shown in FIGS. 1A and 1E.

The components of the web adjuster 100 described above can be manufactured using various suitable materials and methods well known in the art. For example, in some instances the frame 110, the release member 120 and/or the cross bar 140 can be formed from a suitably strong metal, such as a plate steel, that is stamped or otherwise cut in the flat pattern and then bent or otherwise formed to shape. Similarly, the pivot pin 106 can be formed from a suitable steel bar or rod. In some embodiments, the cover 130 can be formed from a suitable plastic material, such as injection molded plastic. In other embodiments, the foregoing components can be manufactured using other suitable materials and methods known in the art, including metallic materials that are cast, machined, forged, etc.

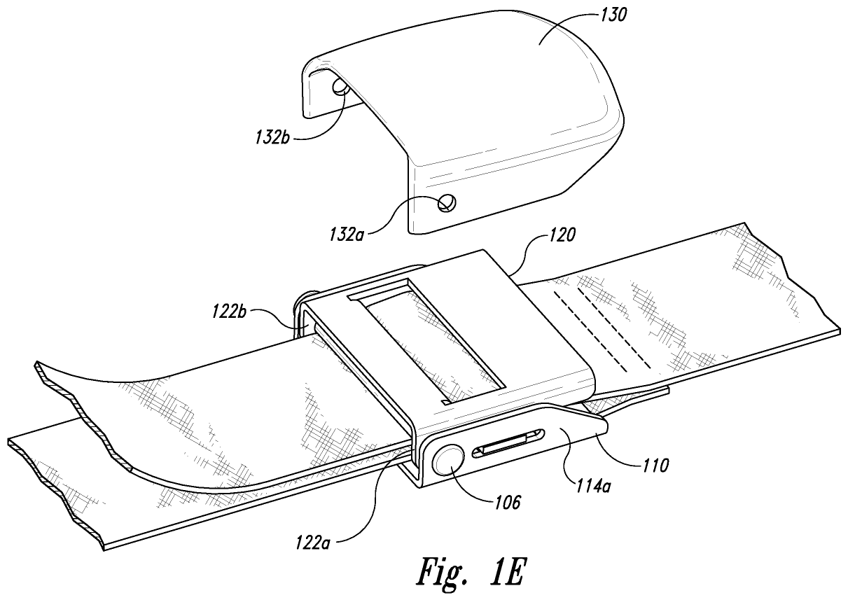

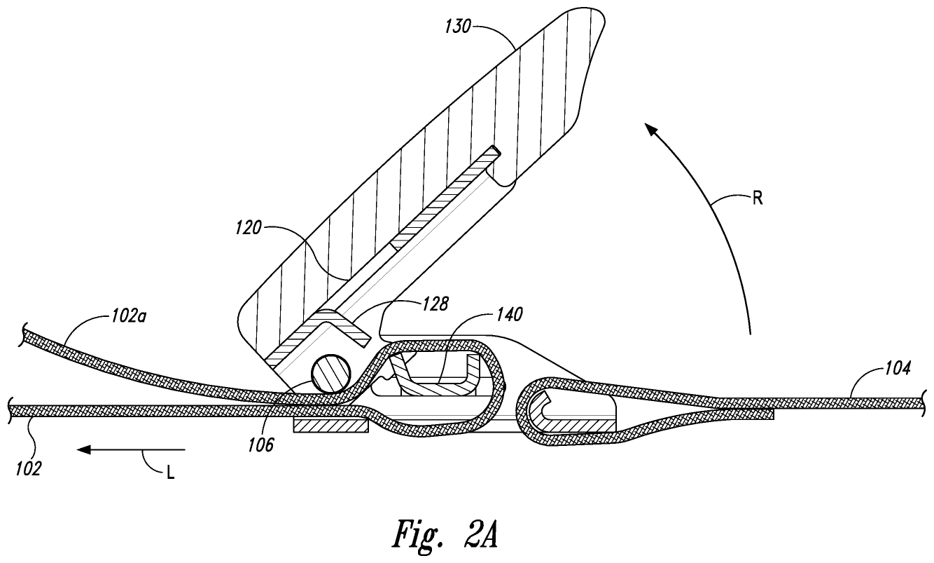

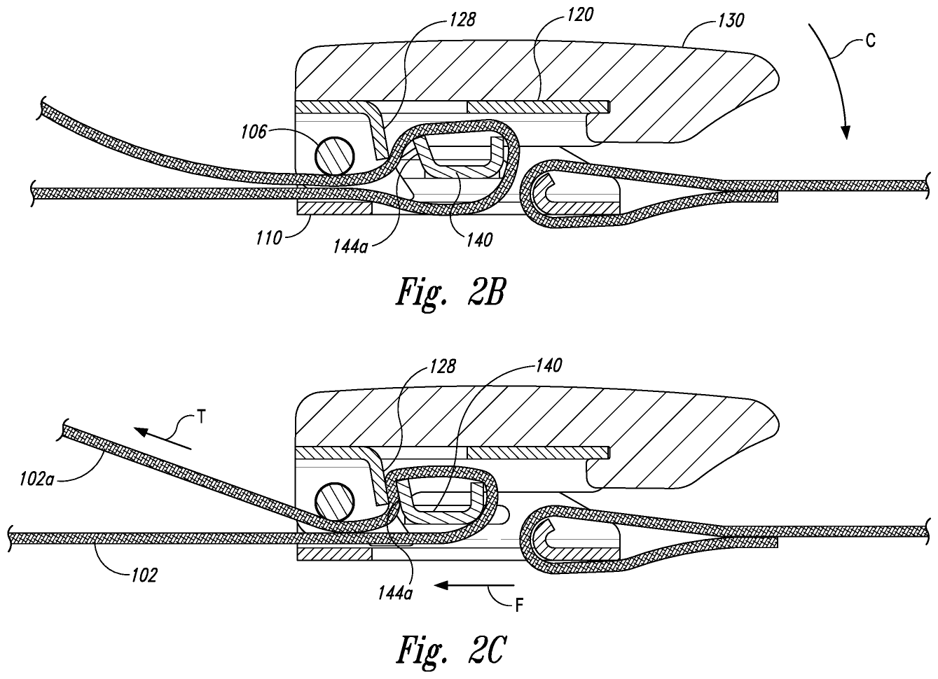

FIGS. 2A-2C are a series of side cross-sectional views illustrating various stages of operation of the web adjuster 100 in accordance with embodiments of the present technology. In FIG. 2A, the cover 130 (and, more specifically, the release member 120) has been rotated away from the frame 110 in direction R to a “release” position. In this position, the locking surface portion 128 of the release member 120 is moved sufficiently away from the cross bar 140 that the first web 102 can move freely between the cross bar 140 and the locking surface portion 128. Additionally, the cross bar 140 is free to slide back and forth in the slots 118a, b. Accordingly, if the first web 102 is under tension when the release member 120 is moved away from the lock position to the release position, moving the release member 120 enables the first web 102 to pull through the web adjuster 100 in direction L, thereby releasing tension in the first and second webs 102 and 104.

Turning next to FIG. 2B, when the user wishes to “lock” the web adjuster 100, the user can do so by rotating the release member 120 toward the frame 110 in direction C. When the stop surfaces 129a, b on the release member 120 (FIG. 1C) contact the base 112 of the frame 110, the release member 120 is in the fully closed or lock position shown in FIG. 2B. In this position, the locking surface portion 128 is positioned generally between the first flange 144a of the cross bar 140 and the pivot pin 106; or put another way, the locking surface portion 128 is positioned generally in front of the cross bar 140 and/or in the path of the cross bar 140.

Turning next to FIG. 2C, to fully lock the web adjuster 100, the user pulls the free end portion 102a of the first web 102 in direction T. This pulls the web 102 through the gap between the first flange portion 144a of the cross bar 140 and the locking surface portion 128. Additionally, as tension in the first web 102 increases, it pulls the cross bar 140 forward in the slots 118a, b in direction F toward the locking surface portion 128. After the user has applied sufficient tension to the free end portion 102a, the user releases the free end portion 102a and the tension in the first web 102 drives the cross bar 140 in direction F to firmly clamp the web 102 between the first flange portion 144a and the locking surface portion 128 and maintain the tension in the first and second webs 102 and 104. In this configuration, the web adjuster 100 is fully “locked” and the webs 102 and 104 can carry their full operating loads without losing tension, or at least without losing substantial tension. When the user wishes to unlock the web adjuster 100 and relieve the tension in the webs 102 and 104, user can rotate the release member 120 away from the frame 110 in direction R as shown in FIG. 2A which, as explained above, moves the locking surface portion 128 away from the cross bar 140 to enlarge the gap therebetween and enable the second web 102 to pass therebetween in direction L.

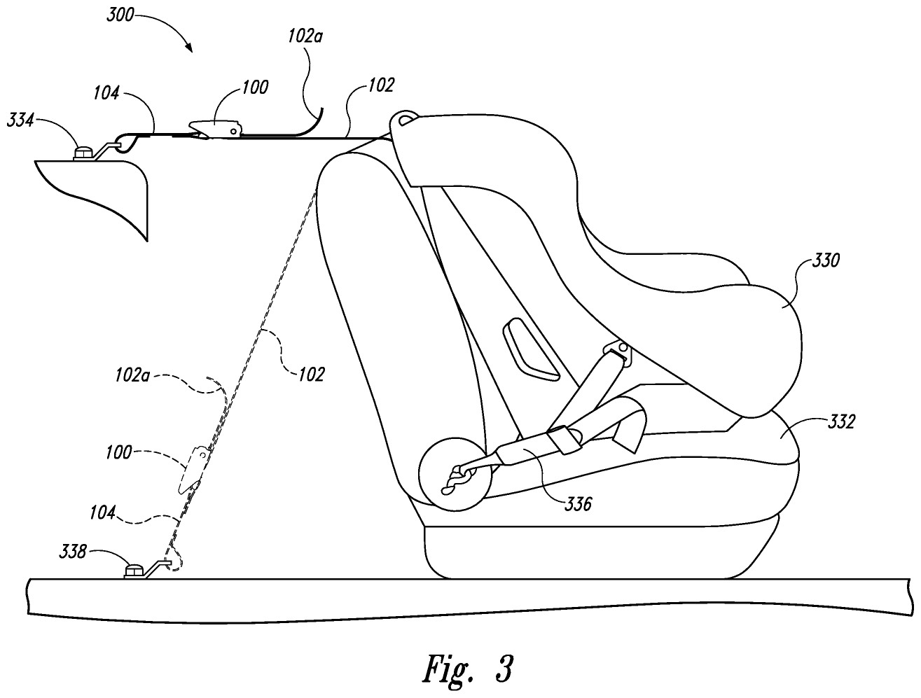

The web adjuster 100 described in detail above can be used in a wide variety of applications. FIG. 3, for example, is a side view of a child seat 330 secured in a car seat 332 with a restraint system 300 that includes the web adjuster 100. In the illustrated embodiment, an upper portion of the child seat 330 is securely attached to an upper anchor 334 in a vehicle (e.g., an automobile) by means of the first web 102 and the second web 104, which are coupled together by the web adjuster 100. Although the upper portion of the child seat 330 is secured to the upper anchor 334, as those of ordinary skill in the art will understand, in other embodiments the upper portion of the child seat 330 and/or other portions of the child seat 330 can be secured to a lower anchor 338 by means of the webs 102 and 104 and the web adjuster 100. A lower portion of the child seat 330 can be secured to the car seat 332 with additional restraints, such as a restraint 336 of a type well known to those of ordinary skill in the art. In other embodiments, the web adjuster 100 can be used with various other web arrangements without departing from the present disclosure.

Referring to FIGS. 2A-3 together, in operation a user can increase the tension in the first web 102 and the second web 104 by grasping the free end portion 102a and pulling it in the direction T as described above with reference to FIG. 2C. When the user releases the free end portion 102a, the tension in the web 102 drives the cross bar 140 toward the locking surface portion 128 of the release member 120, thereby clamping or “locking” the web 102 in position and maintaining the tension in the first and second webs 102 and 104. To release the tension and increase the overall length of the first and second webs 102 and 104 so that, for example, the child seat 330 can be removed from the car seat 332, the user can rotate the cover 130 (and the release member 120) upwardly in direction R. When this happens, it increases the gap between the cross bar 140 and the locking surface portion 128, thereby enabling the free end portion 102a to slip back through the gap to reduce the tension in the first web 102 (and consequently, the second web 104).

There are a number of advantages associated with some embodiments of the web adjuster 100. For example, the mechanical advantage provided by the release member 120 and the configuration of the locking surface portion 128 relative to the cross bar 140 (FIGS. 1B and 1C) can reduce the manual force required to unlock the web adjuster 100, even when the webs 102 and 104 are under substantial tension. In contrast, conventional push-button type web adjusters often have fixed locking surfaces that require the user to apply a release force equal to, or at least approximately equal to, the tension in the webs to effect release. Similarly, conventional tilt lock designs typically require rotation of the entire web adjuster to effect release, which can require significant force when the system is under substantial tension.

References throughout the foregoing description to features, advantages, or similar language do not imply that all the features and advantages that may be realized with the present technology should be or are found in any single embodiment of the present technology. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. One skilled in the relevant art will also recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While the above description describes various embodiments of the invention and the best mode contemplated, regardless how detailed the above text, the invention can be practiced in many ways. Details of a system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A web adjuster for use with a web, the web adjuster comprising:
a frame;
a cross bar movably coupled to the frame and configured to support the web thereon; and
a release member pivotally coupled to the frame and having a locking surface portion, wherein the release member is rotatable between a first position and a second position relative to the frame, wherein the locking surface portion and the cross bar are configured to permit the web to move through a gap therebetween when the release member is in the first position, and wherein the locking surface portion and the cross bar are further configured to clamp the web in the gap therebetween when the release member is in the second position.

2. The web adjuster of claim 1 wherein the cross bar is configured to move fore and aft on the frame, wherein the locking surface portion is generally positioned in a forward path of the cross bar when the release member is in the second position, and wherein the locking surface portion is spaced apart from the forward path when the release member is in the first position.

3. The web adjuster of claim 1, further comprising a pivot pin pivotally coupling the release member to the frame, wherein the locking surface portion is positioned between the pivot pin and the cross bar when the release member is in the second position.

4. The web adjuster of claim 1:
wherein the frame includes a first side wall spaced apart from a second side wall,
wherein the release member is pivotally coupled to the first and second side walls, and
wherein the locking surface portion is operably disposed between the first and second sidewalls.

5. The web adjuster of claim 1 wherein the cross bar is slidably coupled to the frame.

6. The web adjuster of claim 1:
wherein the frame includes a first side wall spaced apart from a second side wall,
wherein the first side wall includes a first slot and the second side wall includes a second slot, and
wherein the cross bar includes a first end portion slidably received in the first slot and a second end portion slidably received in the second slot.

7. The web adjuster of claim 6 wherein the first and second end portions of the cross bar have generally rectangular shapes configured to slide back and forth in the first and second slots, respectively.

8. The web adjuster of claim 1:
wherein the frame includes a base extending between a first side wall and a second side wall,
wherein the release member includes an upper wall extending between a first side flange and a second side flange,
wherein the locking surface portion projects from the upper wall toward the base between the first and second side flanges,
wherein the first and second side flanges are pivotally coupled to the first and second side walls, respectively, and
wherein the cross bar is slidably coupled to the first and second side walls and configured to compress the web against the locking surface portion when the release member is in the second position and tension is applied to the web.

9. The web adjuster of claim 8 wherein the cross bar includes a forward flange spaced apart from an aft flange, wherein the forward and aft flanges extend between the first and second sidewalls and perpendicular thereto, and wherein the forward flange is configured to compress the web against the locking surface portion when the release member is in the second position and tension is applied to the web

10. A restraint system comprising:
a web; and
a web adjuster, wherein the web adjuster includes—
a frame having a base extending between a first side wall and a second side wall;
a cross bar having a first end portion slidably coupled to the first side wall and a second end portion slidably coupled to the second side wall; and
a release member pivotally coupled to the first and second side walls, the release member including a locking surface portion;
wherein the web extends around the cross bar and between the cross bar and the locking surface portion,
wherein the locking surface portion and the cross bar are configured to permit the web to pass therebetween when the release member is in a release position, and
wherein the locking surface portion and the cross bar are further configured to clamp the web therebetween when the release member is in a lock position.

11. The restraint system of claim 10:
wherein the cross bar includes a non-round surface portion, and
wherein non-round surface portion and the locking surface portion are configured to clamp the web therebetween when the release member is in the lock position and tension is applied to a free end portion of the web.

12. The restraint system of claim 10:
wherein the release member includes a first side flange pivotally coupled to the first side wall and a second side flange pivotally coupled to the second side wall, and
wherein the locking surface portion is positioned between the first and second side flanges.

13. The restraint system of claim 12 wherein the release member includes an upper wall extending between the first side flange and the second side flange, and wherein the locking surface portion projects from the upper wall toward the base of the frame.

14. The restraint system of claim 10:
wherein the frame includes a web aperture,
wherein the web is a first web and the restraint system further comprises a second web, and
wherein the second web extends through the web aperture and is attached to itself to secure the frame to the second web.

15. The restraint system of claim 14:
wherein the first web includes a free end portion,
wherein pulling the free end portion of the first web when the release member is in the lock position increases tension in the first and second webs, and
wherein releasing the free end portion after increasing the tension in the first and second webs causes the tension in the first web to drive the cross bar toward the locking surface portion and clamp the first web therebetween.

16. The restraint system of claim 10, further comprising a pivot pin pivotally coupling the release member to the first and second side walls.

17. The restraint system of claim 10, further comprising a pivot pin pivotally coupling a proximal end portion of the release member to the first and second side walls, wherein the release member further includes a distal end portion configured to grasped by a user to rotate the release member about the pivot pin between the lock position and the release position.
